(19) United States
(12) Patent Application Publication
(10) Pub. No.: US 2017/0274588 A1
(43) Pub. Date: Sep. 28, 2017

(54) STRUCTURED BODY AND METHOD FOR ITS PREPARATION

(71) Applicant: SANDVIK TPS Zweigniederlassung der Sandvik Materials Technology Deutschland GmbH, Goeppingen (DE)

(72) Inventors: Frank MAUÉ, Zweibruecken (DE); Matthias KLEINHANS, Waiblingen (DE)

(73) Assignee: SANDVIK TPS Zweigniederlassung der Sandvik Materials Technology Deutschland GmbH, Goeppingen (DE)

(21) Appl. No.: 15/466,278

(22) Filed: Mar. 22, 2017

(30) Foreign Application Priority Data
Mar. 23, 2016 (DE) 10 2016 204 775.2

(51) Int. Cl. B29C 67/00; B33Y 80/00; B33Y 10/00

(52) U.S. Cl. CPC B29C 67/0074; B29C 67/0092; B33Y 10/00; B33Y 80/00; B29K 2101/12

(57) ABSTRACT

The invention relates to a structured body and a method for its preparation, whereby the structured body is produced of at least one powdery starting material by application of heat and/or pressure, and has several layers, whereby the starting material consists predominantly of thermoplastic basic material, and whereby the density of at least two layers of the structured body differ from each other, and whereby at least one layer of lower density contains hollow microspheres.

The invention relates to a structured body containing thermoplastic material and a method for its preparation.

It has been known for a long time, for the purpose of weight reduction, for improving mechanical properties or for other reasons, to produce foamed materials with integral structure—i.e. in a single process. These so-called integral foamed materials or structural foams have an outer skin or an outer shell of high density and an inner shell of a density decreasing toward the core. Thus, e.g., integral foams may be prepared in a direct manner by putting a foamable reaction mixture into a closed mold, the outside of which is cooled. Thereby during the foaming of the reaction mixture an area is formed at the cold inner surface of the mold, where the foaming process is prevented in spite of the foaming agent and a solid skin of a higher density will be formed that contains no foaming cells. A multitude of such methods are described, e.g., in Becker/Braun, Kunststoffhandbuch, Vol. 7, Polyurethane, Hanser Verlag 1993.

Additional ways for producing similar structured constructs, e.g., from thermoplastics, may be achieved by means of the extruder technology. Representative thereof may be mentioned DE 10 2013 103 255 A1. This patent document describes how structural defects may be prevented, when a well-known technical standard procedure for producing PVC foam plates is geometrically optimized regarding the reaction mixture discharge.

In principal, in such methods the material flow is divided into two parts in the nozzle housing, and the outer of which will be cooled down abruptly after nozzle outlet so as to prevent the foaming process in the outer region.

The described well known methods have the disadvantage that the non-foamed outer regions contain foaming agent that is not required and increases the material costs quite unnecessarily. Furthermore, subsequent thermal treatments can rarely be carried out without preventing re-expanding these regions slightly in case of thermoplastic foams. Additionally, the above-described methods do rarely allow the production of sophisticated multilayered structures with e.g. alternating foamed and non-foamed layers.

However, such a layer sequence may be desirable, if in case of a symmetric or asymmetric layer arrangement outer layers of high density are to be produced combined with a core layer also of high density, which is to be separated from outer layers by means of foam layers of low density and at the same time connected therewith. Such a plate arrangement may be required, if a plate is to be produced having better mechanical properties in a central region in the vertical section of the plate.

Of course, such structures may also be produced by preparing the individual layers separately and subsequently connecting, e.g., gluing them to each another laminarly. Such a procedure is very uneconomical because of the necessary large number of single steps and the additional costs of the adhesive material. Furthermore, through such a method the finished product contains polymer-non-compatible material i.e., adhesive material, which makes recycling into individual material groups impossible. In this context, the patent document EP 02004395 B1 may be cited.

Furthermore, it is well known that such adhesive surfaces may perhaps have bad shear strength values, in particular if formulation components of adjacent layers worsen the properties of the adhesive layer due to migration processes. In other words, plasticizer migration out of PVC layers may be soften the adhesive layers, in which case the stiffness and therefore shear strength will be reduced.

The object of the invention is the preparation of a structured body without a part of the above-mentioned disadvantages as well as to find a method for its preparation.

The object is solved according to the invention by means of the features of claim 1 as well as by means of a method for its preparation according to the features of claim 15.

Thus, the invention relates to a structured body, which is prepared from at least one powdery starting material by applying heat and/or pressure, and has several layers, wherein the starting material consists mainly of thermoplastic basic material, and whereby

the density of at least two layers of the structured body differ from each other and,

whereby at least one layer of lower density has hollow microspheres and at least one layer of higher density has no hollow microspheres.

Additionally, in a particular embodiment according to the invention, the hollow microspheres interpenetrate the interface and/or the areas close to the interface of the adjacent layer, preferably the number of hollow microspheres is smaller in the said areas than in the layer of lower density; preferably, this particular situation applies to the entire interface.

According to a further particular embodiment, the hollow microspheres of the respective layer or the layers of lower density are distributed regularly and/or irregularly.

The method according to the invention for preparation of a structured body having at least the features of claim 1 comprises at least the following production steps, which are to be carried out subsequently:
spreading a first starting layer of powdery thermoplastic material of a first type onto a support so as to consolidate a first layer of the structured body in the further production sequence;
spreading at least one further starting layer of a powdery thermoplastic material of a second type or of the first type onto the first layer so as to consolidate a second layer of the structured body in the further production sequence;
wherein the powdery thermoplastic material of at least one of the spread layers contains hollow microspheres;
consolidation of the powdery layers and connecting the adjacent layers by means of heating up the materials with concurrent volume increase and/or partial modifications in the surface of the hollow microspheres which are arranged in a territorially limited area,
applying pressure until the intended overall thickness of the structured body is achieved, and
subsequent cooling down.

The said modifications of the surface of the hollow microspheres may be related to the shape of the surface itself but also to the changes of the surface properties. Thus, according to a further aspect of the invention, the surface of the hollow microspheres in their original state may be quite smooth, which affects the mixing of the starting materials favorably. Thus, in a further production step, in particular during heating and/or pressing of the materials the initially smooth surface becomes rough or parts of the surface protrude spikily from the surface.

The invention is particular characterized by the following partial aspects:
Layers of high density of the structured body/sheet are free of foaming agent so as to enable a further thermal treatment or manipulation of the produced structured body, which may be an intermediate product, without forming a foam-like structure in these layers of higher density, whereby uncontrolled deformations could be generated;
Polymer-non-compatible materials can be avoided to the greatest possible extend in the structured body so as to achieve a better recycling performance;
an alternating sequence of layers with foam-like structure and non-foam-like structure in a structured body may be produced in a simple manner and without assembling and gluing of individual layers, which are prefabricated in separate procedures;
all layers are made according to a basic formulation, i.e. made of a basic material, which contains thermoplastics of a polymer type or of a polymer group;
the material costs of a structured body are lower as compared to hitherto known solutions, because foam agent is only present in areas, where it is needed;
the layers have no sharply defined interface as compared to the structured bodies according to the state of art, but show a border area towards their adjacent layers, wherein components/particles of both layers in this border area permeate one another or intermix so as to create a so-called interlinking;
by means of the invention among other things, a so-called wave-like border area is created which has a positive effect on the increase of the shear strength.

According to the invention, to a support, e.g. to the lower belt of a double belt press or to the mold of a press, in subsequent steps several layers of powdery starting material of one type or different types are spread, whereby all of them contain mainly thermoplastic material, wherein at least to the powdery starting material for at least one of the layers, which will have later on a smaller density, hollow microspheres are admixed before the loading process.

According to a further aspect of the invention, by means of controlled spreading, the penetration depth of particles of the material, which is still to be spread, into the already spread material, may be affected, so as to create a connection layer in the border area of adjoined layers. This will be accomplished, e.g., by variation of the kinetic energy of the spread particles, in particular of the kinetic energy of the hollow microspheres, e.g., by varying the fall height of the spread material, whereby the fall height may be varied optionally through the width of the structured body, which has to be prepared.

According to the invention not only the use of a double-belt press is intended—i.e. a continuous production process —, but also of an intermittent production process, therefore in the scope of the patent application it is not generally spoken of a sheet, but basically of structured bodies.

Generally, a sequence of powdery starting materials is spread onto the extended bottom belt of the double belt press. A double belt press is described, e.g. in the patent document DE 10 2014 110 493 A1 or DE 10 2010 033 578 A1. Generally, these materials consist of the same basic formulation, with the difference that those material layers which will form layers of low density, contain an additional material, which is expandable under the effect of heat. This material consists e.g., of thermoplastic hollow microspheres filled with an expandable gas.

Such materials are, e.g., Expancel Microsphere (Akzo Nobel). These thermoplastic hollow microspheres expand from a starting diameter of about 12 μm up to 150 μm. The wall thickness is reduced from about 2 μm down to about 0.1 μm. The expansion temperature may be varied according to the enclosed gas between 80 and 230° C. The expanded hollow microspheres are very elastic and can scarcely be destroyed in case of pressure load. Furthermore, this material is compatible with the majority of technically interesting thermoplastic polymers.

The scope of the invention includes also the use of hollow microspheres of another type, i.e. such microspheres, which under the influence of heat and/or pressure may change their outer shape, i.e. they may adopt temporarily or permanently an elastic shell surface.

The hollow microspheres may be made of glass with a quite thin shell face, which is however still so thick, that a deformation of its shell face does not cause its crack formation or breakage. According to a further aspect of the invention, the hollow microspheres consist of a thermosetting material or of an inorganic material, or of rubber, or of a rubber-like material. Which of the described types of hollow microspheres are used for the preparation of the structured body, eventually depends on the intended application of the structured body and its resultant necessary properties.

According to a further aspect of the invention, the use of a mixture of hollow microspheres of different kinds/types is productive.

It is advantageous for the invention to keep the grain size of the spreading materials of the basic formulation at the magnitude of the sphere dimensions of the used hollow microspheres, so as to achieve a good mixture and to prevent a separation when the spread powder or powder mixture impacts on the already spread layer. Therefore, it is an essential feature of the invention to use powder for the layers, which are to be spread, with an average grain size of as small as about 250 μm, preferably smaller than 250 μm.

Such powders may be readily prepared, e.g., be using PVC as thermoplastic material with addition of the standard additives of the known heating-cooling-mixing process; e.g., by means of a method for preparing a thermoplastic powder according to the patent application DE 10 2015 000 262.7 of the applicant.

It has been shown, that an addition of hollow microspheres to the basic formulation does not influence the mixing result negatively and that also spreadable powders or powder mixtures can be prepared, which do not separate.

Such a method, i.e. the inventive method is generally not restricted to PVC formulations, but may also be realized with other thermoplastic polymers.

Furthermore, it is crucial for the functionality of the method for preparing a structured body according to the invention, that the addition of hollow microspheres to the basic formulation does not cause a substantial change of the rheological behavior during the melting process, i.e., that the powder particles show an identic melting performance, which is independent of the added hollow microspheres, so that a homogenous distribution of components can be formed.

Further advantageous embodiments of the inventive structured body and of the method for its preparation result from features of the subclaims.

Thus, the transition area between two adjoining layers, the interface, in particular between layers of different densities, is made up of a connection layer, which consists of particles/components of both of these layers, which are mixed and form-fitted and/or substance-bounded.

It is advantageous, if the thickness of the connecting interface is at least 5%, preferably 10% and not more than 30% of the thickness of the adjoining thicker layer.

Hereinafter the inventive structured body is explained further and more detailed by means of embodiments shown by schematic figures, but the invention is not limited to these particular embodiments.

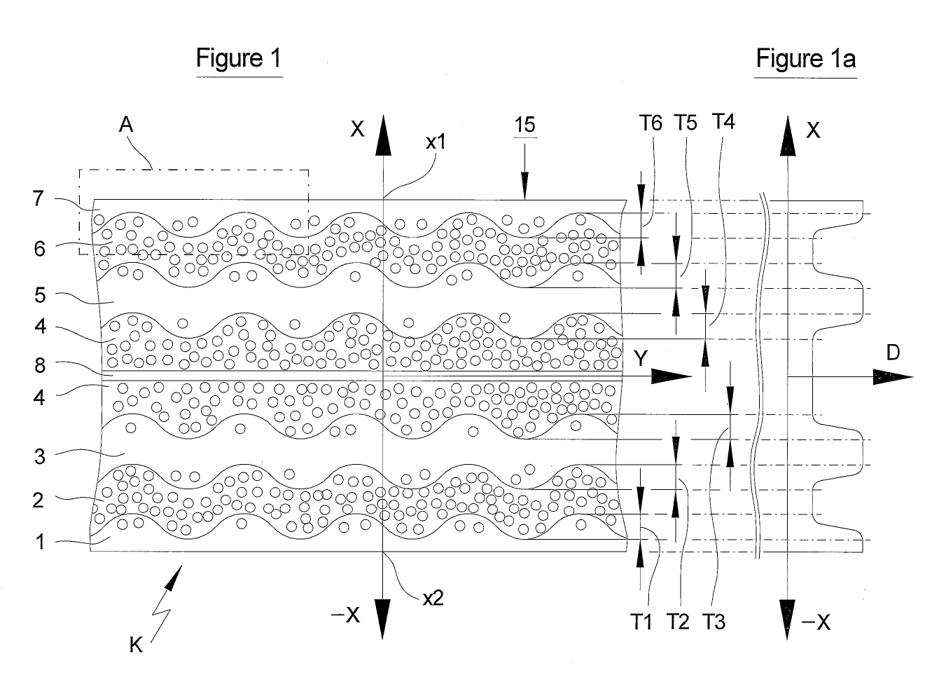

FIG. 1 shows a vertical section of a structured body with several layers of different densities;

FIG. 1a shows a diagram of the density D versus the thickness of the structured body;

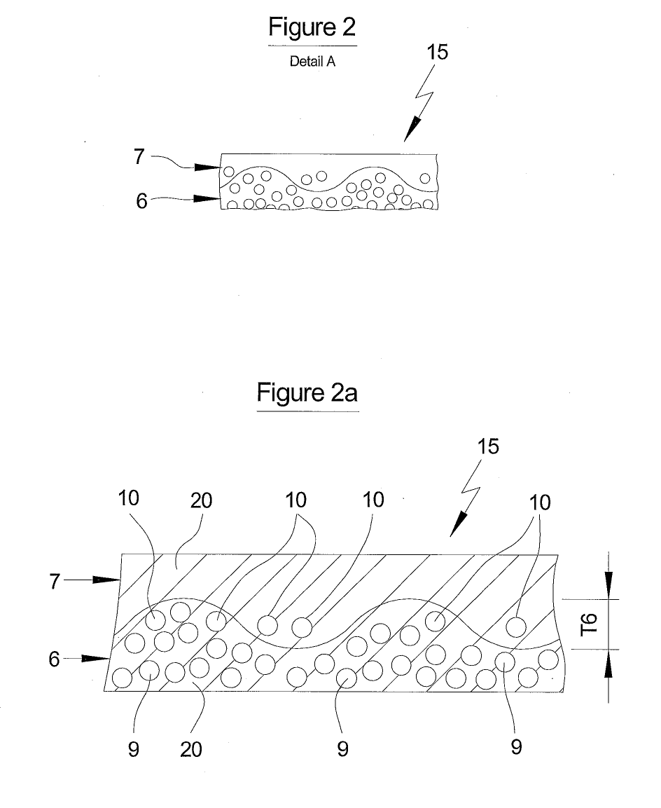

FIG. 2 shows part A of the FIG. 1;

FIG. 2a shows an enlarged FIG. 2;

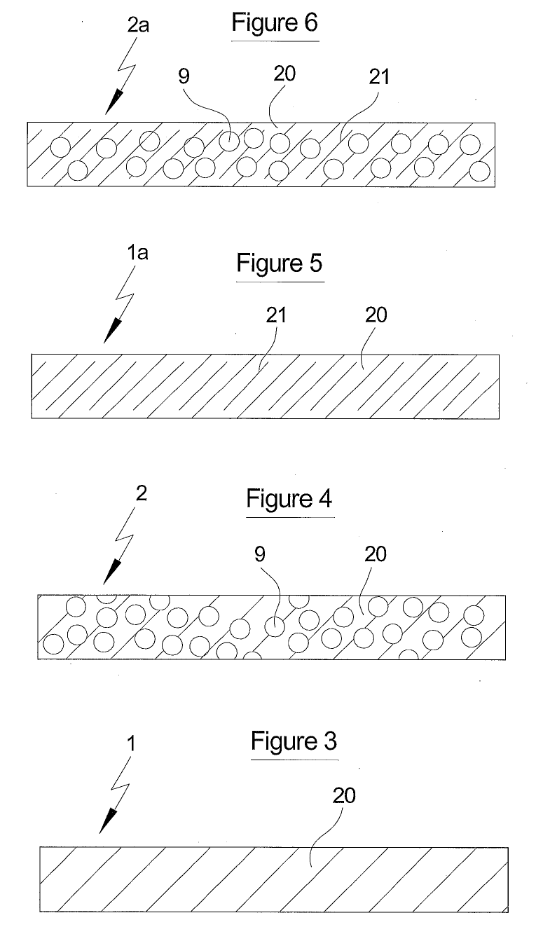

FIG. 3 shows a first layer of the inventive structured body;

FIG. 4 shows a second layer of the inventive structured body;

FIG. 5 shows a modified first layer of the inventive structured body;

FIG. 6 shows a modified second layer of the inventive structured body;

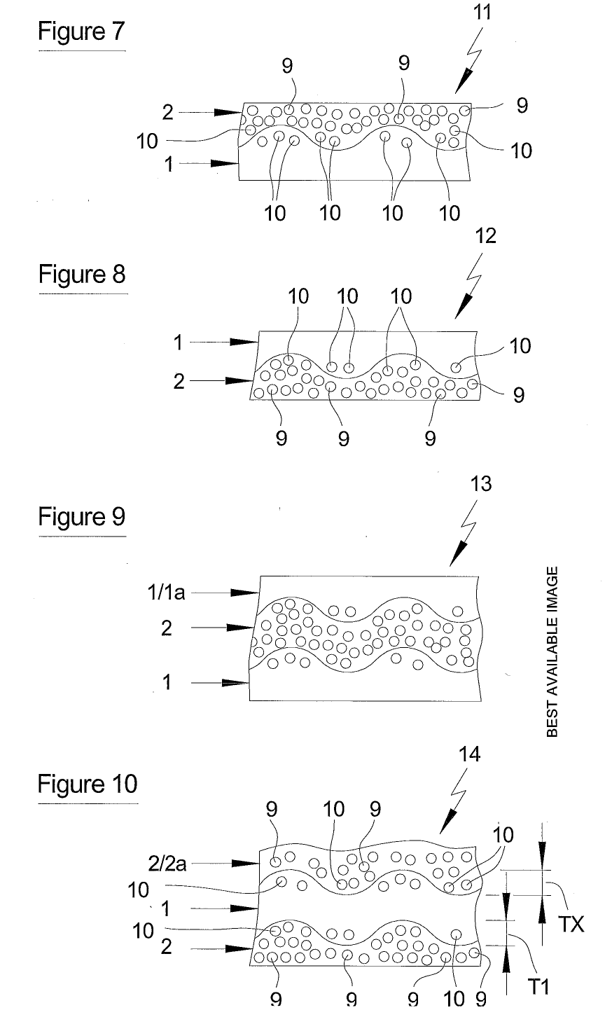

FIG. 7 shows a vertical section of a first structured body;

FIG. 8 shows a vertical section of a second structured body;

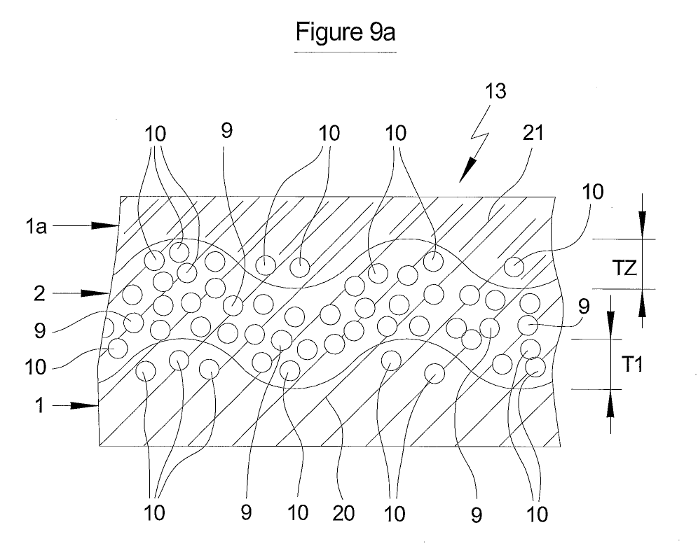

FIG. 9 shows a vertical section of a third structured body;

FIG. 9a shows the structured body according to FIG. 9 in an enlargement;

FIG. 10 shows a vertical section of a fourth structured body.

The reference signs of the figures have the same meaning in each figure, even if they are not specified explicitly in the description of each of the embodiments. In the description not mentioned reference signs can be taken from the reference sign list.

Terms like “left”, “right”, “top” or “bottom” are only terms related to the figures, in the arrangement of a practical implementation there may be other positions. Furthermore, it may be mentioned, that the figures are not pure technical drawings, therefore some hatching lines and break-off leaders are missing. Additionally, the relative dimensions may differ from the reality.

FIG. 1 shows a cross section through an inventive structured body K, which is in this case a sheet-like structured body 15. On the left and right-hand side of this figure, the structured body 15 has break-off leaders, which indicate there the proceeding of this object. A coordinate system with X- and Y-axes is in the center of the structured body 15. The small circles 9 and 10 designate expanded hollow microspheres in the finished structured body 15 (i.e., after heating, pressing and cooling).

The figure shows that only in each interface of the layers 1, 3, 5 and 7, i.e. in the transition areas T1, T2, T3, T4, T5 and T6 there are expanded hollow microspheres; whereby their number in these areas is essentially smaller than in the neighboring layers 2, 4 and 6. Therefore, each of the layers 1, 3, 5, and 7 has a higher density and each of the layers 2, 4, and 6 has a lower density. The layers 2, 4, and 6 are therefore lighter and softer or more elastic than the other four layers.

In addition, in the center of this structured body 15 a support material 8 in the shape of a textile is arranged for stability reasons.

In this embodiment of the sheet-like structured body 15 of the inventive method for preparing this structured body K the transition areas T1, T2, T3, T4, T5, and T6 are wave-shaped. Thus, a quasi-interlinking T is achieved, i.e. a form-fitted and/or greater substance bounded connection of the layers of low density with layers of higher density or even high density. By means of the horizontal dash-dotted lines across to FIG. 1a the technical and mathematical assignment of the density D to the layers in FIG. 1 is shown. The waved lines of FIG. 1 represent only imaginary envelopes and not abrupt borderlines, as it becomes evident from the graphics of FIG. 1a.

The wave shape may be steady or unsteady, whereby a single wave line may has unsteady and steady segments. According to a further aspect of the invention, one wave line of a transition area has a steady wave form and a second wave line of this transition area has an unsteady wave form. By means of this further measure, the interlinking may be varied and may be adapted more advantageously to the used starting materials.

FIG. 2 shows section “A” of FIG. 1, and FIG. 2a is the enlarged presentation of FIG. 2. The upper layer 7 has essentially no hollow microspheres, however, into its section of interface T6 hollow microspheres 10 are immigrated/diffused, which during the course of spreading the powdery material of the first type, i.e. of a thermoplastic basic material 20 for forming a seventh layer 7, onto the already spread sixth layer 6 consisting of a powdery basic material 20 and admixed hollow microspheres 9, migrated from the accumulation of hollow microspheres 9, and settled there after the further production process/proceeding, which follows the spreading, in order to improve the so-called interlinking of the layers.

The layer 7 is substantially denser and therefore harder or more rigid as compared to layer 6.

In order to achieve an identical melting behavior as far as possible, e.g., the following PVC basic formulation is proposed for the powder for the foamable alternative—for the layer or layers of smaller density—and for the non-foamable alternative—for the layer or layers of higher density. The given quantities are not limiting quantities, they are only wishful:

| | Foamable basic | Non-foamable |
|---|---|---|
| | alternative | alternative |
| Component | (figures in percent) | (figures in percent) |
| S-PVC (K55-K65) | 50-70 | 50-70 |
| PVC copolymer | 10-30 | 10-30 |
| Plasticizer | 20-25 | 20-25 |
| Co-plasticizer | 3-5 | 3-5 |
| Stabilizer | 2-3 | 2-3 |
| Process auxiliaries | 0.5-1.5 | 0.5-1.5 |
| Filler including fiber filler | 20-80 | 20-80 |
| Hollow microspheres | 1.5 | 0 |

The table shows that due to the extraordinary small portion of hollow microspheres of the formulation for the foamable alternative there is no essential difference between both of the specified formulations in relation to the components. In particular, the formulations show that the requirement resulting from the object of the invention for avoiding polymer-non-compatible materials, in particular for avoiding different polymers or polymer groups in the alternatives is met. The marginal admixture of other polymers by means of the shell material of the hollow microspheres can be ignored.

Thereby, recycling processes will not be disturbed.

FIGS. 3 to 6 show exemplary and schematically different layers each consisting of a different material.

FIG. 3 shows a first layer 1 having a higher density, which exists also in the structured body 15 according to FIG. 1. This first layer consists of a material of a first type, of a thermoplastic basic material 20, e.g., a material according to the basic formulation listed in the shown table.

FIG. 4 shows a second layer 2 having a low density. This second layer 2 consists of a material of the first type, i.e. also of a thermoplastic basic material 20 and admixed hollow microspheres 9.

FIG. 5 shows a modified first layer having a higher density. This modified first layer 1a consists of a material of a second type consisting of a thermoplastic basic material 20 and additives 21.

FIG. 6 shows a modified second layer 2a having a low density. This modified second layer 2a consists of a material of a second type, consisting of a thermoplastic basic material 20 and additives 21 and admixed hollow microspheres 9.

Due to the close similarity of the spreading materials alternatives in relation to the rheological and intrusion behavior, it is made sure, that during the process of spreading the layers one above the other a reproducible layer sequence is formed, which is characterized in that the particles of two successively spread materials become mixed only because of impact processes during the spreading in the respective interfaces T1, T2, T3, T4, T5, or T6. Thus, in combination with the following process steps of thermal treatment and/or pressing, the desired interlinking of the specified layers is ensured. The expanding of the expandable or deformable particles in this interface, i.e., in particular of the hollow microspheres, encloses the surrounding non-expanded particles during the melting and/or pressing process at least in part, preferably mainly or completely, and thus leads to a vertical permeation of both materials in a certain vertical area.

The expansion of the particles according to the invention is the expanding process and/or deformation process of the hollow microspheres, e.g. a quasi-volume increase of the hollow microspheres, which is also called foaming up by experts, and/or an at least partial deformation of their spherical surface, by which areas of the spherical surface partially get elevations and/or recesses, e.g., concave and/or convex sectors, which promotes also the interlinking.

Thus, a continuous phase of the material of the basic formulation results across both of the adjoining layers 7 and 6, or layers 6 and 5, or layers 5 and 4, or layers 4 and 3, or layers 3 and 2, or layers 2 and 1.

In case of several subsequent layers, as just described, a continuity of the basic material across the whole cross-section of the structured body K is achieved.

The quality of permeation of this area is defined by the grain size distribution of the spread materials and by the kinetics of the foaming process or of the room requiring deformation process.

Equally essential for a good interlinking is the temperature control during the melting and foaming process. The so-called foaming agent has to be selected in such a manner, that the expanding process starts only, when the melting process got substantially started, i.e., that by the expansion process no solid material can be displaced from the interface. For instance, in case of the above-described formulations the expanding processes of the hollow microspheres should start only above 150° C.

If in a further embodiment of the invention three layers of powdery material according to the above specified exemplary formulations are subsequently brought onto a running bottom belt of a double-belt press by means of a spreading device, so that a non-foamable layer is followed by a foamable layer and then again a non-foamable layer follows, then two of the previously specified interfaces are generated. A subsequent thermal treatment with an appropriate temperature control related to the preceding melting process and the subsequent foaming process generates a three-layered sheet, which meets the set requirements. The sheet has two outer layers of higher density without foaming agent and a core of lower density with foam-structure, i.e., a foamable framework, for this see also FIGS. 9 and 9a, thus a third structured body 13 will be produced.

The density ratios and the mechanical and physical-chemical properties may be varied very simply by variation of the basic formulations without any problems according to changing requirements on the final product; this is shown schematically in FIG. 9a by means of the modified first layer 1a. The modified first layer 1a consists of a material of a second type, which consist of a thermoplastic basic material 20 and additives 21. The powdery material of a second type may be a mixture of both of the components 20 and 21 or both of the components 20 and 21 were already bound together during the production of the body for the production of the powdery material of a second type and are therefore present in each powder grain.

The inventive method for production of a structured body is superior to the already known technologies for the production of objects made of integral foams regarding the profitability and the possible variations.

Further variations of this new method result in the possible variation of the layers of the final product, i.e., of the structured body K. For instance, a first structured body 11 shown in a sectional view in FIG. 7 has at the bottom a first layer 1 of higher density and above this first layer 1 a second layer 2 of low density 2.

A second structured body 12 shown, in the section view in FIG. 8 has at the bottom a second layer 2 of low density and above this layer 2 a first layer of higher density.

A third structured body 13 shown in FIGS. 9 and 9a in a sectional view has at the bottom a first layer 1 of higher density and above this first layer 1 a second layer 2 of low density and above the second layer 2 a modified first layer 1a of higher density or a first layer 1 of higher density. The transition area/interface between the two upper layers is tagged in this case with the reference sign TZ so as to discriminate to the structured body 15 according to FIG. 1. This interface TZ has likewise as the lower interface T1 hollow microspheres 10 arranged in a scattered way, the positive effect of which was already described previously.

A fourth structured body 14 shown in a sectional view has at the bottom a second layer 2 of low density and above this layer 2 a first layer 1 of higher density and above the first layer 1 a modified second layer 2a of low density or a second layer 2 of low density. The transition area/interface between the layer 1 and the layer 2 has scattered hollow microspheres 10 similar to the interface T1 of the structured body 15 according to the embodiment of the invention according to FIG. 1. The interface between the layer 1 and the layer 2a is in this case tagged by means of the reference sign TX. This interface TX has also scattered hollow microspheres 10.

It may be required to generate within a foamed core layer a layer of higher density so as to have the possibility e.g., to anchor mechanical fastening elements or to incorporate lateral tongue and groove profiles. Such an enforcement may be achieved according to the invention in such a manner, that onto a lower non-foamable layer, which is followed by a foamable layer, a centrally located non-foamable layer is spread, which itself is followed by a foamable layer, which is covered by a non-foamable layer. Thus a symmetrically arranged five-layered object is produced having a core of a high density and outer surfaces of high density. Of course, the sequence of these layers is not limited to the described example.

Furthermore, it is possible to replace or reinforce the central layer by means of a support material 8, preferably a prefabricated sheet, such as e.g., textile substrates, glass fleece, laid webs, endless fibers, or plastic foils, which are introduced between the respective spreading steps. Within the scope of the invention the carrier or the foil may also made of a non-thermoplastic material.

Additionally, a sheet or structured body may be made with layers of low density at one or both of the outer sides and a core of high density. Such products are used e.g., if construction panels are laid onto uneven surfaces and a horizontal adjustment has to be made. Uneven surfaces press into the rather soft outer side of the laid panel and enable an even surface contact.

Further alternative methods for further improving the mechanical properties of the prepared products include the admixture of stiffening fiber materials to the basic formulations. This may occur in case of the non-foaming alternatives as well as in case of the foaming alternatives and simultaneously in both of the alternatives. In particular, the use of such fiber fillers in the external layers is appropriate, because thereby the compressive strength and/or the flexural strength can be increased substantially.

It turned out to be also advantageous, if strengthening fibers, also endless fibers—independent of the basic materials—are spread or introduced by means of separated spreading steps below or above the respective powder layers. In the subsequent thermal process, these fibers are melted into the polymer matrix. This procedure has the advantage that also fibers may be used, which because of their dimensions not already can be integrated in the basic spreading materials during the preceding mixing procedure, because they would disturb the homogeneity of the spreading materials and therefore the spreading steps.

Structured bodies/sheets produced in this manner allow for density reductions up to 100% in relation to products without foam structures with comparable mechanical properties. Thereby it is quite possible by means of the inventive method to vary the number of layers, their properties and their sequence.

The invention is not limited to the presented and described embodiments. The claims of this patent application are only suggested formulations without prejudice to achieve any further patent protection.

Thus, for example, in a structured body K. according to the invention the layer or layers of higher density—viewed along the X-direction, i.e. in the direction of its smallest length extension—may be located in the border area (X1, X2) of the structured body, as it is exemplary shown in FIG. 1. Furthermore, the layers of different densities, viewed along the X-direction, may differ from each other several times.

According to further embodiments of the invention, in at least one layer of lower density the hollow microspheres are distributed in a statistic manner.

Or/and the structured body K consists of 90% thermoplastics of one polymer type or of one polymer group.

Or/and the polymer type or the polymer group of the basic material, i.e. of the basic formulation, is PVC.

Or/and the density of adjoined layers differ from each other in at least 20%.

### LIST OF REFERENCE SIGNS

1 first layer (of higher density, consisting of a material of a first type)
1a modified first layer (of higher density, consisting of a material of a second type)
2 second layer (of low density; consisting of a material of a first type with expanded hollow microspheres)
2a modified second layer (of low density; consisting of a material of a second type with expanded hollow microspheres)
3 third layer (of higher density
4 fourth layer (of medium density; with expanded hollow microspheres)
5 fifth layer (of higher density)
6 sixth layer (of low density; with expanded hollow microspheres)
7 seventh layer (of higher density)
8 support material (fibers, webs, laid webs, glass fibers)
9 hollow microspheres (in a layer of low density)
10 hollow microspheres (hollow microspheres 9 migrated or diffused into an interface)
11 first structured body
12 second structured body
13 third structured body
14 fourth structured body
15 fifth structured body (sheet-like)
20 thermoplastic basic material
21 additives
X1 X-value of the upper surface
X2 X-value of the lower surface
Y axis of the width of the structured body
T1, T2, T3,
T4, T5, T6,
Tx, Tz interfaces (transition areas between adjoined layers, preferably wave-like)
D measure of density
K structured body

1. Structured body (K) prepared from at least one powdery starting material by application of heat and/or pressure and comprising several layers, wherein
the starting material consists predominantly of a thermoplastic basic material,
the density of at least two of the several layers (1, 2, 1a, 2a, 3, 4, 5, 6, 7) of the structured body (K) differ from each other,
at least one layer of lower density (2; 2a; 4; 6) contains hollow microspheres (9).

2. Structured body (K) according to claim 1,
wherein
the hollow microspheres (9) are regularly or/and irregularly distributed in the respective layer (2; 2a; 4; 6).

3. Structured body (K) according to claim 1,
wherein
the hollow microspheres permeate partially the interface (T1; T2; T3; T4; T5; T6; Tx; Tz) to the adjoined layer (1; 3; 5; 7) and/or the area close to the adjoined layer (1; 3; 5; 7).

4. Structured body (K) according to claim 1,
wherein
the structured body (K) is sheet-like.

5. Structured body (K) according to claim 1,
wherein
the layer or layers, which is/are located in the X-direction, i.e. viewed along the direction of its (K) smallest length extension, in the border area (X1, X2) of the structured body (K), is/are a layer or layers of higher density (1; 1a; 7).

6. Structured body (K) according to claim 1
wherein
the layers of different density (1, 2, 3; 1, 2, 1; 1, 2, 1a; 2, 1, 2; 2, 1, 2a; 2, 3, 4; 4, 5, 6; 5, 6, 7), when viewed along the X-direction, at least differ once from each other.

7. Structured body (K) according to claim 1
wherein
at least two of the several layers have a different density.

8. Structured body (K) according to claim 1
wherein
a support material (8) is located in at least one of the layers (1, 2, 1a, 2a, 3, 4, 5, 6, 7) or between two adjoining layers of these layers, wherein the support material (8) consists of fibers, or of a web, or of a laid web, or of a fleece, or of a combination of these just specified materials.

9. Structured body (K) according to claim 1
wherein
in at least one layer of lower density (2; 2a; 4; 6), the hollow microspheres (9) are statistically distributed and arranged.

10. Structured body (K) according to claim 1
wherein
the structured body (K) consists up to 90% of thermoplastics of one polymer type or one polymer group.

11. Structured body (K) according to claim 10
wherein
the polymer type or the polymer group is PVC.

12. Structured body (K) according to claim 1
wherein the density of adjoining layers differ from each other in at least 20%.

13. Structured body (K) according to claim 1
wherein the transition area between adjoining layers, i.e. the interfaces (T1; T2; T3; T4; T5; T6; Tx; Tz), in particular between layers of different density, is formed of a joining layer, which is made up of particles/components of both of these layers, which in turn are mixed among each other and connected to each other in a form-fitted and/or substance-bounded manner.

14. Thermoplastic structured body (K) according to claim 13, wherein the thickness of the joining interface (T1; T2; T3; T4; T5; T6; Tx; Tz) is at least 5%, preferably 10% and not more than 30% of the thickness of the adjoining thicker layer.

15. Method for production of a structured body (K) with the succeeding process steps:
spreading a layer (1) of a powdery thermoplastic material of a first type onto a supporting layer;
spreading of at least a further, second layer (2) of a powdery thermoplastic material of a second type or of a first type onto the first layer;
whereby the powdery thermoplastic material of at least one of the spread layers contains hollow microspheres;
consolidating the powdery layers and connecting adjoined layers by means of heating the materials and simultaneous expanding of the hollow microspheres, which are arranged territorially limited,
pressing to the intended overall thickness of the structured body (K) and
subsequent cooling down.

16. Method according to claim 15, comprising the following process steps
spreading a third layer (3) of a powdery thermoplastic material of a first type or of a second type or of a further modified type onto the second layer (2),
if need be, spreading further layers (4; 6; 7; 8) in the same sequence as for the first (1) and the second layer (29);
consolidating the powdery layers and connecting adjoining layers by means of heating the materials and simultaneous expanding of the hollow microspheres, which are arranged territorially limited,
pressing to the intended overall thickness of the structured body (K) and
subsequent cooling down.

17. Method according to claim 15,
wherein
the structured body (K) is produced in a continuous production process, i.e., on a conveyer belt, preferably on a double belt press.

18. Method according to claim 15,
wherein
by means of controlled spreading, the penetrating depth of particles of the material, which is still to be spread, into the already spread material, is affected in order to form a joining face in the boundary area of adjoined layers, for instance by means of variation of the kinetic energy, for instance by means of variation of the dropping height of the material to be spread, whereby the dropping height may optionally be varied by means of the width of the structured body (K) to be produced.

19. Method according to claim 15,
wherein
when spreading the layers, also fiber material is spread into one or several layers.

20. Method according to claim 15,
wherein
into one of the layers or between two adjoined layers, a support material (8) is inserted, for instance a fiber sheet, a laid web, a web, or endless fibers.

21. Method according to claim 15,
wherein
the outer surface of the structured body (K) is laminated with a further layer.
